(19) United States
(12) Patent Application Publication
(10) Pub. No.: US 2008/0149647 A1
(43) Pub. Date: Jun. 26, 2008

(54) Side-opening waste container and method

(76) Inventors: Robert M. Geurink, Mosinee, WI (US); David P. Ott, Wausau, WI (US); John E. Peterson, Wausau, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/643,726

(22) Filed: Dec. 21, 2006

(51) Int. Cl. B65F 1/00

(52) U.S. Cl. 220/669; 220/676; 29/428

(57) ABSTRACT

A waste container comprising a housing including a wall, the wall defining a surface area and a plurality of apertures, a door defining a surface area and a plurality of apertures, a hinge pin configured to rotatably support the door on the housing, and a thrust bearing between the door and the housing, wherein the apertures in the wall comprise at least 39% of the surface area defined by the wall, and wherein the apertures in the door comprise at least 39% of the surface area defined by the door.

### BACKGROUND

Many waste containers are constructed using heavy and bulky materials. For example, many waste containers for commercial and/or outdoor use employ thick and heavy construction materials for sidewalls, doors, and other container components. Although often providing the advantage of container strength, such container designs typically use material inefficiently, resulting in a significant increase in container weight, manufacturing and shipping costs, and a more expensive waste container.

Some waste container designs include a door pivotably connected to a housing for access to an interior of the waste container. Such waste containers often have an expensive hinge assembly capable of supporting the weight of a conventional door and the loads experienced by the door in use. The container normally has an inefficient structural design matching that of the hinge to which it is connected in order to insure a reasonably long door life. Particularly in light of the ever-increasing raw material costs of metal, plastic, and other waste container construction materials, a demand exists for waste containers that have a more efficient design, are easier to manufacture, and/or can be manufactured at reduced costs without sacrificing container durability.

### SUMMARY

Some embodiments of the present invention provide a waste container, comprising a housing comprising a wall defining an exterior surface of the waste container and having a surface area, the wall having a first plurality of apertures extending therethrough, the first plurality of apertures occupying at least 39% of the surface area of the wall; a hinge pin coupled to the housing; a thrust bearing coupled to the housing; and a door pivotably coupled to the housing by the hinge pin, supported by the thrust bearing, and defining another exterior surface of the waste container and having a surface area, the door pivotable between opened and closed positions with respect to the housing; the thrust bearing and the hinge pin carrying a reduced load from the door by virtue of a second plurality of apertures extending through the door and occupying at least 39% of the surface area of the door.

In some embodiments, a method of assembling a waste container is provided, and comprises coupling a thrust bearing to one of a housing and a door of the waste container; positioning the door adjacent an opening of the housing; coupling a hinge pin to the thrust bearing; coupling the door to the housing via the hinge pin, the door having an exterior surface area; supporting a load from the door upon the hinge pin and thrust bearing, the load defined in part by a plurality of apertures extending through the door, the plurality of apertures distributed across and occupying at least 39% of the exterior surface area of the door; and rotating the door between opened and closed positions with respect to the housing.

Some embodiments of the present invention provide a waste container comprising: a door comprising a first body defining an exterior of the door and partially defining an exterior of the waste container; a housing comprising a second body defining an exterior of the housing and partially defining the exterior of the waste container; a hinge pin extending and coupled to a first plate on the door and a second plate on the housing, the door pivotable about a rotational axis of the hinge pin between opened and closed positions with respect to the housing; a first reinforcing plate coupled to the first plate on the door; a second reinforcing plate coupled to the second plate on the housing; and a thrust bearing coupled to the hinge pin, wherein the door includes a substantially rigid sheet defining the exterior of the door and through which a plurality of apertures are defined, the apertures occupying at least 39% of the exterior of the door.

Further aspects of the present invention, together with the organization and operation thereof, will become apparent from the following detailed description of the invention when taken in conjunction with the accompanying drawings, wherein like elements have like numerals throughout the drawings.

### BRIEF DESCRIPTION OF THE DRAWINGS

FIG. 1 is a perspective view of a waste container illustrating an embodiment of the present invention;

FIG. 2 is an exploded perspective view of the waste container illustrated in FIG. 1;

FIG. 3 is an alternate perspective view of the waste container illustrated in FIGS. 1 and 2, shown with the lid removed;

FIG. 4 is a perspective view of a hinge assembly of the waste container illustrated in FIGS. 1-3;

FIG. 5 is a cross-sectional view of the hinge assembly of the waste container illustrated in FIGS. 1-4, taken along line 5-5 of FIG. 4;

FIG. 6 is a perspective view of an upper hinge portion of the waste container illustrated in FIGS. 1-5;

FIG. 7 is a perspective view of a door of the waste container illustrated in FIGS. 1-6;

FIG. 8 is a perspective view of a hinge portion of the door of the waste container illustrated in FIGS. 1-7;

FIG. 9 is a perspective view of a base assembly of the waste container illustrated in FIGS. 1-8;

FIG. 10 is a perspective view of a lower hinge portion of the waste container illustrated in FIGS. 1-9.

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

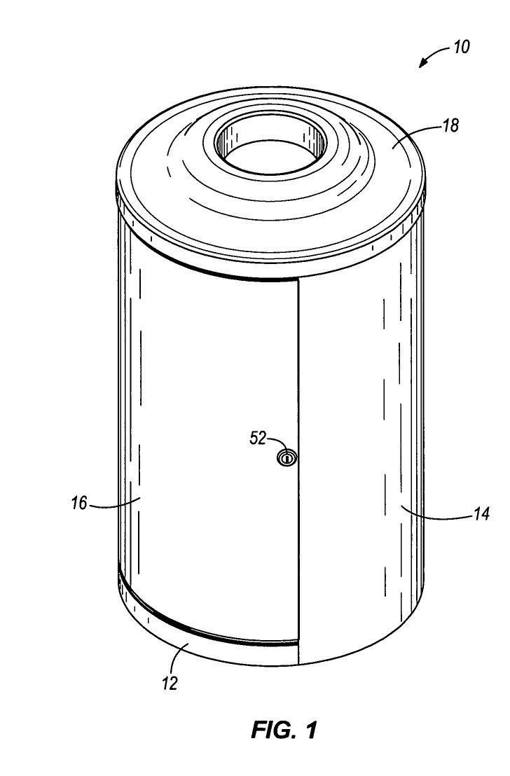

A waste container according to an embodiment of the present invention is illustrated in FIGS. 1-10, and is indicated generally at 10. The waste container 10 illustrated in FIGS. 1-10 is generally cylindrical, and includes a housing 14, a door 16, and a lid 18. In some embodiments, the waste container 10 can also include a base 12 and/or an upper support 15, either or both of which can be integrally formed with the housing 14 or a separate element connected to the housing 14. A round housing can provide a number of significant advantages, including a desirable door shape (discussed in greater detail below), reduced resistance to wind, and other advantages. However, in other embodiments, the waste container 10 can have different shapes, such as rectangular or other polygonal shapes, oval shapes, and irregular shapes.

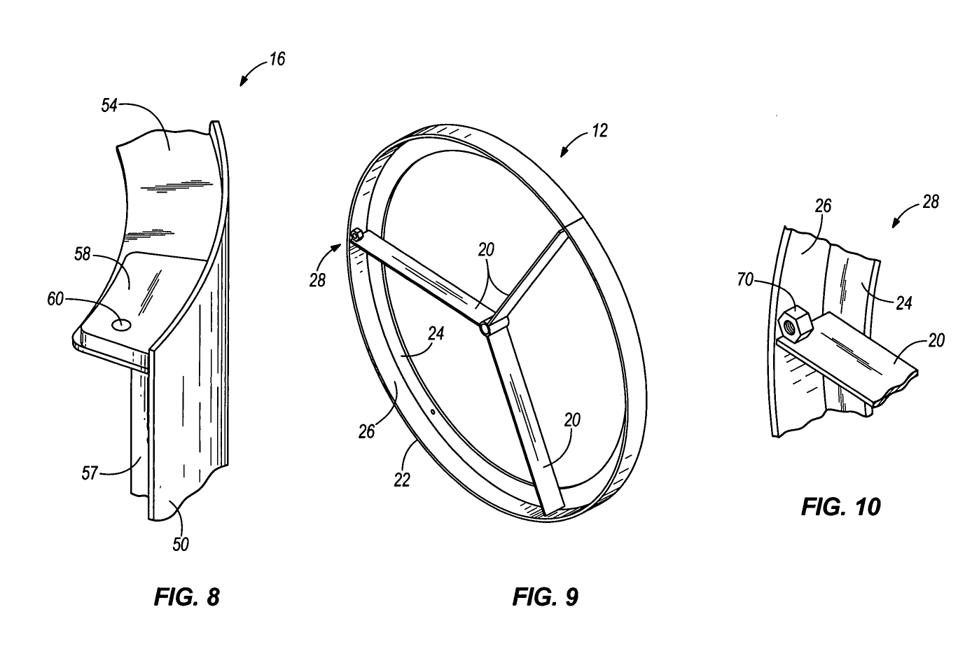

As best shown in FIG. 9, the base 12 of the illustrated embodiment includes cross members 20 coupled to an annular support ring 22 having a flat bottom portion 24 and a vertical portion 26 extending vertically from the flat bottom portion 24. The cross members 20 extend from the support ring 22 toward the middle of the base 12 and help to stiffen the base 12. In some embodiments, the base 12 can be stiffened by elements or structure other than cross members 20, such as by a grid of wires or rods connected to and within the support ring 22, a solid or perforated bottom wall connected to and within the support ring 22, or by a rigid mesh wall connected to and within the support ring 22. As best shown in FIG. 10, the illustrated base 12 also includes a lower hinge portion 28, which is explained in greater detail below. In some embodiments, such as those in which the base 12 is formed integrally with the housing 14, the lower hinge portion 28 can be connected to the housing 14 rather than to the base 12.

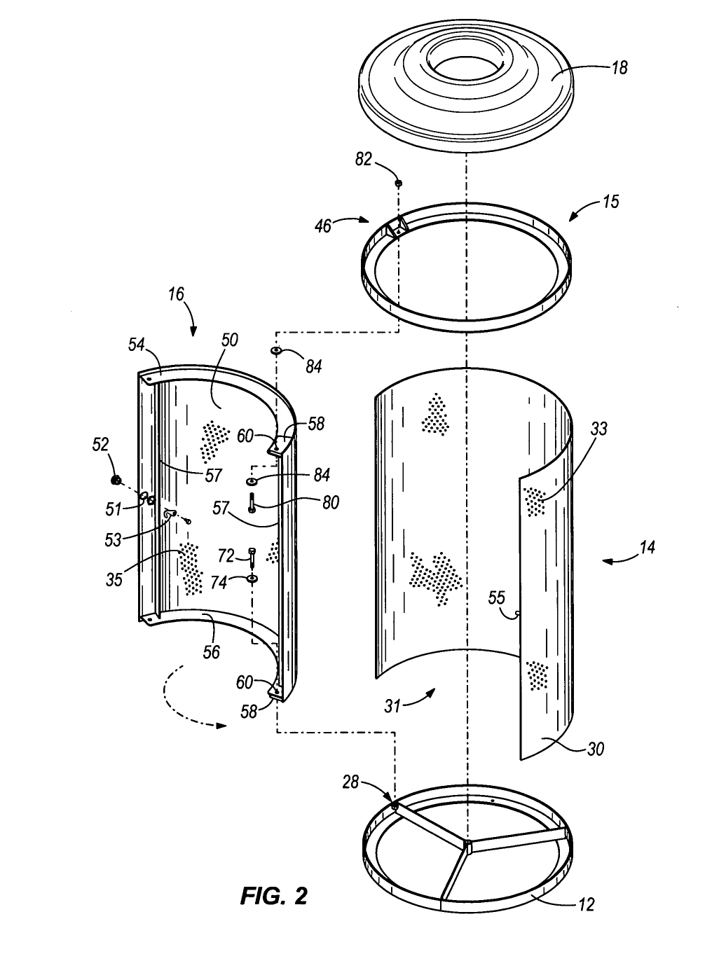

With reference back to FIG. 2, the illustrated housing 14 is defined in part by a generally cylindrical wall 30. The wall 30 includes an open region 31 that is substantially covered by the door 16 when the waste container 10 is assembled and the door 16 is closed. In some embodiments, the wall 30 is made from steel having a thickness of at least 1/16″ and no greater than 3/16″ thick. The wall 30 can include apertures 33 extending through the wall 30 to provide airflow into and out of the waste container 10 and to decrease the weight of the housing 14. The apertures 33 can have any shape, including round, oval, polygonal, or any other desired shape. The shape and/or size of the apertures 33 can be consistent across the wall 30, or alternatively the shape and/or size of the apertures 33 can vary across the wall 30. The apertures 33 can have generally any size, but an average size no smaller than about 0.463 inches and no greater than about 0.502 inches in largest dimension (e.g., diameter for round apertures 33, length for elongated apertures 33, and the like) is desired in many applications. In other applications, the apertures 33 have an average size no greater than about 0.75 inches and no less than about 0.25 inches to provide good performance results. The apertures 33 can be located anywhere on the wall 30, and can be arranged in patterns or in random and patternless locations across the wall 30. By way of example only, the apertures 33 can be located only in certain regions of the wall 30, such as only in the center portion of the wall 30, only in regions on opposite sides of the housing 14, and the like. In other embodiments, the apertures 33 can cover substantially the entire wall 30. In the illustrated embodiment, the wall 30 has apertures 33 extending substantially across all surfaces of the wall 30, although only a few apertures 33 are shown for clarity. In some embodiments, apertures 35 covering at least about 39% of the surface area of the wall 30 can be used for good performance results.

In some embodiments, the wall 30 can be made from perforated steel, perforated aluminum, or any other suitably rigid material. The diameter of the illustrated housing 14 can be such that the vertical portion 26 of the base 12 fits inside the housing 14. In other embodiments, the housing 14 can fit within the vertical portion 26 of the base 12, the base 12 can abut the housing 14 and be connected thereto in any suitable manner, the base 12 can be snap-fit to the housing 14 or can be connected thereto by any type of inter-engaging elements on the housing 14 and base 12, or as mentioned earlier, the base 12 can be formed integrally with the housing 14. In some embodiments, the vertical portion 26 of the base 12 is be secured to the housing 14 by welding or brazing, by any number of screws, rivets, pins, clamps, or other fasteners, by inter-engaging elements on the base 12 and wall 30 as mentioned above, by a press-fit connection between the base 12 and wall 30, or any other suitable manner of attachment. In other embodiments, other portions of the base 12 can be attached to the wall 30 depending at least in part upon the shape of the base 12.

As best shown in FIGS. 2 and 4-6, the upper support 15 of the illustrated embodiment includes a vertical portion 42 and a substantially horizontal portion 44 extending from the vertical portion toward the middle of the upper support 15. The upper support 15 helps to stiffen the housing 14, and can include cross members similar to the base 12. In some embodiments, the upper support 15 can be stiffened by elements or structure other than cross members, such as by connecting a grid of wires or rods within the upper support 15, connecting a solid or perforated bottom wall within the upper support 15, or by connecting a rigid mesh wall within the upper support 15. In the event that any of these stiffening methods is used, they can still be shaped to provide an aperture through which waste can be placed into the waste container 10.

In other embodiments, the housing 14 can fit within the vertical portion 42 of the upper support 15, the upper support 15 can abut the housing 14 and be connected thereto in any suitable manner, the upper support 15 can be snap-fit to the housing 14 or can be connected thereto by any type of inter-engaging elements on the housing 14 and upper support 15, or the upper support 15 can be formed integrally with the housing 14. In some embodiments, the vertical portion 42 of the upper support 15 can be secured to the housing 14 by welding or brazing, by any number of screws, rivets, pins, clamps, or other fasteners, by inter-engaging elements on the upper support 15 and wall 30, by a press-fit connection between the upper support 15 and wall 30, or any other suitable manner of attachment. In other embodiments, other portions of the upper support 15 can be attached to the wall 30 depending at least in part upon the shape of the upper support 15. The upper support 15 illustrated in FIGS. 2-6 can also include an upper hinge portion 46, which will be explained in greater detail below. In some embodiments, such as those in which the upper support 15 is integrally formed with the housing 14, the upper hinge portion 46 can be connected to the housing 14 rather than the upper support 15.

The door 16 of the illustrated embodiment is defined at least in part by a curved wall 50, although other shapes of the door 16 are possible, and fall within the spirit and scope of the present invention. The door 16 illustrated in FIGS. 1-5, 7, and 8 includes an aperture 51 configured to receive a latch 52. The aperture 51 and latch 52 can be located anywhere on the door 16 for convenient user access. As best shown in FIG. 2, the latch 52 of the illustrated embodiment can include a cam 53 that can be rotated by inserting and rotating a key in the latch 52. The cam 53 can engage a post 55 positioned on the inner surface of the housing 14 to secure the door 16 with respect to the body 14. In some embodiments, engaging the post 55 with cam 53 can adjust position of the door 16 with respect to the housing in a vertical, horizontal, diagonal, or any other direction to improve the position of the door 16 with respect to the body 14.

The illustrated door 16 also has an upper brace 54, a lower brace 56, and vertical braces 57. When the waste container 10 is assembled, the curved shape of the wall 50 in the illustrated embodiment completes the substantially cylindrical shape of the housing 14. In some embodiments, the wall 50 is made from steel having a thickness of at least 1/16″ and no greater than 3/16″. The wall 50 can include apertures 35 to provide airflow into and out of the waste container 10 and to decrease the weight of the door 16. The apertures 35 can have any shape, including round, oval, polygonal, or any other desired shape. The shape and/or size of the apertures 35 can be consistent across the wall 50, or alternatively the shape and/or size of the apertures 35 can vary across the wall 50. The apertures 35 can have generally any size, but an average size no smaller than about 0.463 inches and no greater than about 0.502 inches in largest dimension (e.g., diameter for round apertures 35, length for elongated apertures 35, and the like) is desired in many applications. In other applications, the apertures 35 have an average size no greater than about 0.75 inches and no less than about 0.25 inches to provide good performance results. The apertures 35 can be located anywhere on the wall 50, and can be arranged in patterns or in random and patternless locations across the wall 50. By way of example only, the apertures 35 can be located only in certain regions of the wall 50, such as only in the center portion of the wall 50 or only at the top, bottom, and/or sides of the wall 50. In other embodiments, the apertures 35 can cover substantially the entire wall 50. In the illustrated embodiment, the wall 50 has apertures 35 extending substantially across all surfaces of the wall 50, although only a few apertures 35 are shown for clarity.

The weight of the door 16 and the forces generated by the door 16 in its various positions with respect to the housing 14 have a significant impact upon the characteristics and performance of the door hinge (described in greater detail below) and the housing 14. The inventors have discovered a relationship between the construction of the door 16 and that of the hinge and/or housing 14 that permits the use of a relatively lightweight door hinge and a reduction in the strength and material requirements of the housing 14 while still providing a strong and durable waste container 10. In some embodiments, the wall 50 can be made from perforated steel, perforated aluminum, or any other suitably rigid material. The inventors have also discovered that in some embodiments, apertures 35 covering at least about 39% of the surface area of the wall 50 (and in some embodiments having a material thickness and/or the dimensions described above) can be used for good performance results.

The shape of the door 16 can significantly impact the relationship between the door 16, the hinge (described below), and the housing 14. In the illustrated embodiment, a curved wall 50 of the door 16 provides a reduced torque on the hinge portions 28, 46, and therefore a reduced torque upon the housing 14. By virtue of the apertures and resulting reduced weight of the door 16, still lower torque is exerted upon the hinge portions 28, 46. Other door shapes can be utilized to provide a smaller moment arm with respect to the hinge portions 28, 46, including non-planar door shapes having the same surface area as planar door shapes.

In some embodiments, the door 16 is reinforced in order to maintain a desired relationship between material thickness, door weight, and aperture amount described above. For example, the door 16 in the illustrated embodiment has substantially horizontal upper and lower braces 54, 56 that extend inward from the wall 50 toward the middle of the waste container 10. The upper and lower braces 54, 56 and the vertical braces 57 of the illustrated door 16 help stiffen and strengthen the door 16. In some embodiments, different styles and quantities of door reinforcing elements can be used, and can take a number of different forms. For example, the wall 50 of the door 16 can also or instead be provided with one or more gussets, reinforcing brackets, braces, and the like. Such reinforcing elements can be connected to the top and bottom of the door 16 to provide reinforcement for the hinge portions 28, 46.

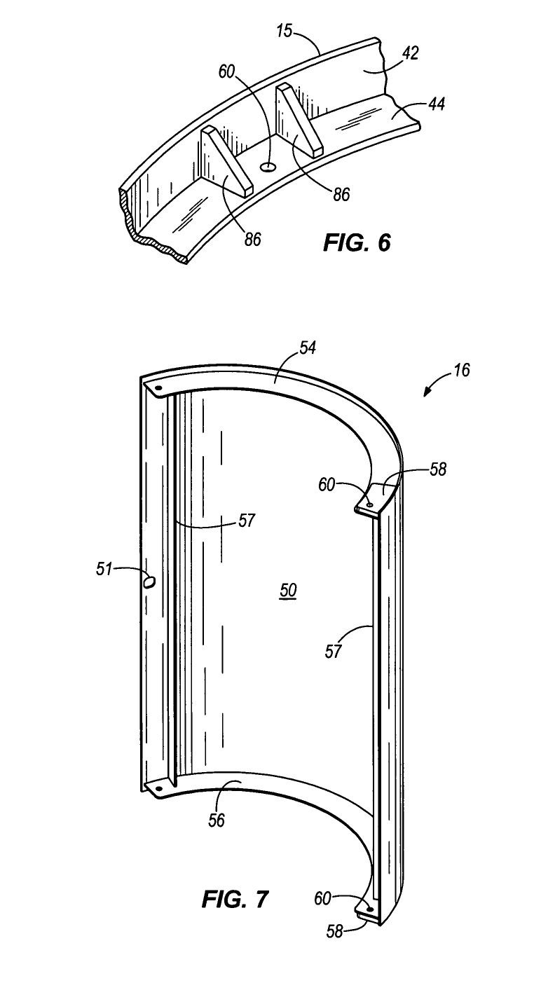

As best shown in FIGS. 7 and 8, the upper and lower braces 54, 56 of the illustrated waste container 10 also include reinforcing plates 58 coupled to the braces 54, 56. Apertures 60 extend through the plates 58 and through the upper and lower braces 54, 56. The apertures 60 permit the door 16 to be coupled to the upper and lower hinge portions 46, 28 and permit the door 16 to pivot with respect to the housing 14 about the upper and lower hinge portions 46, 28. The upper and/or lower braces 54, 56 of the door 16 can also or instead be reinforced with other reinforcing plates, such as gussets (e.g., similar to the gussets 86 described below), and the like.

The door 16 of the illustrated waste container 10 is pivotally coupled to the waste container 10 by the lower hinge portion 28 and the upper hinge portion 46. In the illustrated embodiment of FIGS. 1-10, the lower hinge portion 28 includes a threaded fastener (such as a nut 70) connected to the base 12. As best shown in FIG. 10, the nut 70 is connected to the base 12 between one of the cross members 20 and the vertical portion 26, although any other suitable location on the base 12 and/or on the housing wall 30 is possible. The nut 70 can be connected to the base 12 by welding, brazing, or in any other suitable manner. The door 16 in the illustrated embodiment is positioned on the waste container 10 such that the aperture 60 in the plate 58 connected to the lower brace 56 is aligned with the nut 70 on the base 12. With reference to FIG. 2, a hinge pin 72 extends through the aperture 60 and is threaded into the nut 70. In the illustrated embodiment, the hinge pin 72 is a threaded fastener such as a bolt. In other embodiments, the hinge pin 72 can be a smooth pin. With continued reference to FIG. 2, a washer 74 is positioned between the door 16 and the base 12 such that the hinge pin 72 extends through the washer 74. The washer 74 helps to reduce friction between the door 16 and the base 12.

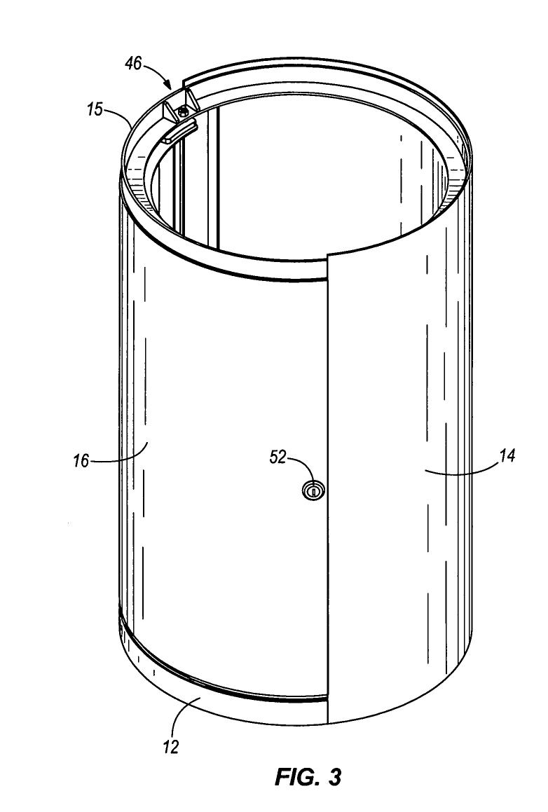

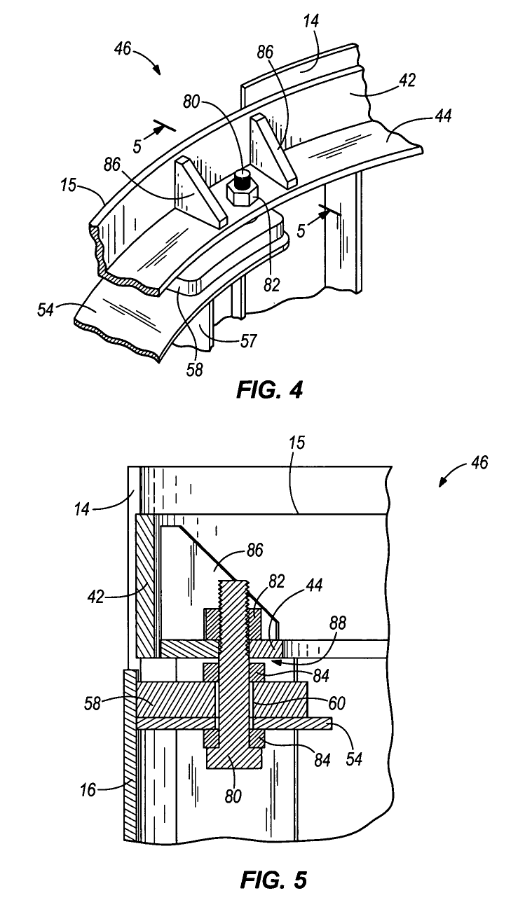

As best shown in FIGS. 4-6, the upper hinge portion 46 of the illustrated embodiment includes an upper hinge pin 80, a nut 82, and bearings 84. In the illustrated embodiment, the hinge pin 80 includes a threaded portion similar to a threaded fastener. In other embodiments, the hinge pin 80 can be a smooth pin. As best shown in FIG. 5, the hinge pin 80 extends through the upper brace 54 of the door 16, through the plate 58, and through the horizontal portion 44 of the upper support 15. Also with reference to FIG. 5, bearings 84 are disposed on the hinge pin 80 beneath the upper brace 54 and between the plate 58 and the horizontal portion 44 of the upper support 15. The bearings 84 help reduce friction between the door 16 and the upper hinge portion 46, and can also assist in distributing the weight of the door 16 among the components of the hinge portion 46. In the illustrated embodiment, the bearings 84 are thrust bearings. In other embodiments, other types of bearings and/or bushings can be used.

With continued reference to the illustrated embodiment of the waste container 10, the hinge pin 80 is threaded into the nut 82 adjacent the horizontal portion 44 of the upper support 15. The hinge pin 80 is threaded into the nut 82 such that the nut 82 can transfer substantially all of the weight of the door 16 to the horizontal portion 44. The upper support 15 includes gussets 86 coupled between the vertical portion 42 and the horizontal portion 44 to help reinforce and stiffen the upper support 15. The upper support 15 can also or instead be reinforced with other reinforcing plates, such as plates similar to the plates 58 of the door 16 discussed above. For example, such plates could be positioned on the vertical portion 42 and/or the horizontal portion 44 to help reinforce and stiffen the upper support 15.

The door 16 in the illustrated embodiment can be raised and lowered with respect to the rest of the waste container 10 by threading the hinge pin 80 into or out of the nut 82. The door 16 can be raised far enough to remove a significant amount, most, or substantially all of the weight of the door 16 from the lower hinge portion 28. A gap 88 exists between the plate 58 and the horizontal portion 44 of the upper support 15 to permit the door 16 to be raised as described. Depending on the construction of the hinge portions 28, 46, the hinge pins 72, 80 can be replaced with other elements providing different manners of adjusting the height of the door 16. For example, a pin can have multiple circumferential grooves spaced along a length of the pin, any one of which can receive a C-clip for supporting at least part of the weight of the door 16. As another example, a pin having multiple holes spaced along a length of the pin can be employed, wherein a cotter pin can be inserted in any one of the holes for supporting at least part of the weight of the door 16. Still other manners of door height adjustment are possible, and fall within the spirit and scope of the present invention.

As described above with reference to the illustrated embodiment, the lower hinge portion 28 has a hinge pin 72 extending into a nut 28 on the base 12, and the upper hinge portion 46 has a hinge pin 80 extending through aperture 60 in the upper support 15. It should be noted that other pin and aperture arrangements can be employed to perform the same or similar function. For example, the nut 28 can be replaced with a pin fixed to the base 12 for engagement with the door 16, and/or the upper support 15 can have a pin fixed thereto for engagement with the door 16. In these embodiments, the door 16 can include hinge portions configured to receive the pins fixed to the base 12 and the upper support 15 to rotatably support the door 16 with respect to the housing 14. Also, in some embodiments, the door 16 can be coupled to the waste container 10 with a single long hinge pin extending between the hinge portions 28, 46 to rotatably support the door 16 on the housing 14. It should also be noted that still other relationships between the door 16, hinge pins, base 12, and upper support 15 are possible, and fall within the spirit and scope of the present invention.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

What is claimed is:

1. A waste container comprising:
a housing comprising a wall defining an exterior surface of the waste container and having a surface area, the wall having a first plurality of apertures extending therethrough, the first plurality of apertures occupying at least 39% of the surface area of the wall;
a hinge pin coupled to the housing;
a thrust bearing coupled to the housing; and
a door pivotably coupled to the housing by the hinge pin, supported by the thrust bearing, and defining another exterior surface of the waste container and having a surface area, the door pivotable between opened and closed positions with respect to the housing;
the thrust bearing and the hinge pin carrying a reduced load from the door by virtue of a second plurality of apertures extending through the door and occupying at least 39% of the surface area of the door.

2. The waste container as claimed in claim 1, wherein the thrust bearing and hinge pin also carry a reduced torque load from the door by virtue of a curved shape of the door.

3. The waste container as claimed in claim 1, wherein the wall includes a thickness no less than about 1/16″ and no greater than about 3/16″.

4. The waste container as claimed in claim 1, wherein the door includes a thickness no less than about 1/16″ and no greater than about 3/16″.

5. The waste container as claimed in claim 1, wherein the hinge pin is a threaded fastener.

6. The waste container as claimed in claim 1, wherein the thrust bearing is located between the hinge pin and the door.

7. The waste container as claimed in claim 1, wherein the wall and door together define a round shape of the housing in the closed position of the door.

8. The waste container as claimed in claim 1, wherein the housing further comprises:
a plate to which the hinge pin is coupled;
a reinforcing gusset coupled and supporting load carried by the plate from the door.

9. The waste container as claimed in claim 1, wherein:
the door has a height with respect to the housing proximate the hinge pin; and
the height of the door proximate the hinge pin is adjustable.

10. A method of assembling a waste container, the method comprising:
coupling a thrust bearing to one of a housing and a door of the waste container;
positioning the door adjacent an opening of the housing;
coupling a hinge pin to the thrust bearing;
coupling the door to the housing via the hinge pin, the door having an exterior surface area;
supporting a load from the door upon the hinge pin and thrust bearing, the load defined in part by a plurality of apertures extending through the door, the plurality of apertures distributed across and occupying at least 39% of the exterior surface area of the door; and
rotating the door between opened and closed positions with respect to the housing.

11. The method of claim 10, wherein:
the housing has an exterior surface area; and
another plurality of apertures extend through the housing, and are distributed across and occupy at least 39% of the exterior surface area of the housing.

12. The method of claim 10, wherein the wall includes a thickness no less than about 1/16″ and no greater than about 3/16″.

13. The method of claim 10, wherein the door includes a thickness no less than about 1/16″ and no greater than about 3/16″.

14. The method of claim 10, wherein coupling the hinge pin to the thrust bearing comprises inserting a threaded portion of the hinge pin through the thrust bearing.

15. The method of claim 10, further comprising:
coupling the hinge pin to a plate on the housing; and
supporting load from the door upon the plate by a gusset coupled to the plate.

16. The method of claim 10, further comprising adjusting a height of the door after coupling the door to the housing via the hinge pin.

17. A waste container comprising:
a door comprising a first body defining an exterior of the door and partially defining an exterior of the waste container;
a housing comprising a second body defining an exterior of the housing and partially defining the exterior of the waste container;
a hinge pin extending and coupled to a first plate on the door and a second plate on the housing, the door pivotable about a rotational axis of the hinge pin between opened and closed positions with respect to the housing;
a first reinforcing plate coupled to the first plate on the door;
a second reinforcing plate coupled to the second plate on the housing; and
a thrust bearing coupled to the hinge pin,
wherein the door includes a substantially rigid sheet defining the exterior of the door and through which a plurality of apertures are defined, the apertures occupying at least 39% of the exterior of the door.

18. The waste container as claimed in claim 17, wherein the rigid sheet is no less than about 1/16″ and no greater than about 3/16″ thick.

19. The waste container as claimed in claim 17, wherein the door has a curved shape.

20. The waste container as claimed in claim 17, wherein the hinge pin is a threaded fastener.
